(19) United States
(12) Patent Application Publication
(10) Pub. No.: US 2003/0046372 A1
(43) Pub. Date: Mar. 6, 2003

(54) System, apparatus, and method to configure a server in the field

(76) Inventor: Jonathan M. Traxler, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/945,128

(22) Filed: Aug. 31, 2001

(51) Int. Cl. G06F 15/16; G06F 15/177

(52) U.S. Cl. 709/220; 709/203

(57) ABSTRACT

A method, apparatus, and system in which a first server restores a digital image to a second server after the initial payload has been installed. Response logic associated with the first server responds to a broadcast request of the second server to restore the digital image. A network circuit associated with the first server transmits the digital image over a network connection.

### FIELD OF THE INVENTION

This invention generally relates to creating, restoring, or rebuilding a digital image in a server.

### BACKGROUND OF THE INVENTION

A server is a hardware computerized-device in a network shared by multiple users. The server may have preinstalled software to perform a dedicated service. For example, Web server refers to a computer system dedicated to a Web server application. Likewise, mail servers, database servers, print servers, network access server and other similar servers exist to perform the corresponding function.

A personal computer maybe manufactured to be a general-purpose machine and can be programmed by an end user to become, for example, a photo workstation, a game console, or a word processor. The end user may need to change a few of the operating system settings to switch between game programs and photo programs. A server usually requires an end user to ship the hardware back to manufacturer in order to fundamentally change the purpose of a server. The manufacturer would then use a coded key, such as a digital signature, to bum a new digital image into the server hardware in order to change the purpose of a server, for example, as a mail server to a print server.

A digital image is usually a file in a compressed file format that contains an exact replica of the applications, operating system, and configuration settings of the source computerized device at the time when the digital image was created. A payload is the operating system and base applications at any given period in time, such as when the server is shipped. The manufacturer typically tests all the programs and operating system in the payload to ensure that the programs can function properly and not conflict with one another. The manufacturer then creates a digital image of the operating applications, operating system, and configuration settings to fabricate servers that should operate without crashing. The digital image contains the files like a copy function but also contains registry files, configuration files, and any other files to make an exact replica of the source-computerized device. Essentially, the digital image contains everything needed, in a compressed format, to restore a system to an earlier, working configuration.

Companies use digital imaging for a number of reasons such as when they want to create identical configurations and install the same files on numerous machines. For instance, if a manufacturer needs to build 100 laptops, then instead of manually setting configurations, and installing applications on each machine, the digital imaging techniques load the compressed digital image on each machine.

After a server is preinstalled with its initial payload then the server is shipped to the customer or third party vendors. Both a customer or a third party vendor may install further application software and data files on top of the payload. A problem occurs when something such as a virus or a software bug crashes the server and forces the system payload to have to be restored. The customer needs to restore the server back to the operating configuration that existed just prior to the crash. Currently, the manufacturer sends a restore CD ROM disk that contains the factory digital image, i.e. the initial payload. The customer must manually load the CD ROM disk into each server that crashed and then reload each additional application and data file that added to the customer's server after initial payload was installed.

### SUMMARY OF THE INVENTION

A method, apparatus, and system in which a first server restores a digital image to a second server after the initial payload has been installed. Response logic associated with the first server responds to a broadcast request of the second server to restore the digital image. A network circuit associated with the first server transmits the digital image over a network connection to the second server.

### BRIEF DESCRIPTION OF THE DRAWINGS

The drawings refer to the invention in which:

FIG. 1 illustrates a block diagram of an embodiment of a field-configure-server; and

FIG. 2 illustrates a block diagram of a field-configure-server loading digital images in several different ways.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific data signals, named components, connections, number of servers, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention. The term “coupled” is defined as meaning connected either directly or indirectly.

In general, a first server, such as a field-configure-server, restores a digital image to one or more remote servers after the initial payload has been installed. Response logic associated with the first server responds to a broadcast request of one or more of the remote servers to restore the digital image. A network circuit associated with the first server transmits the digital image over a network connection to the one or more remote servers.

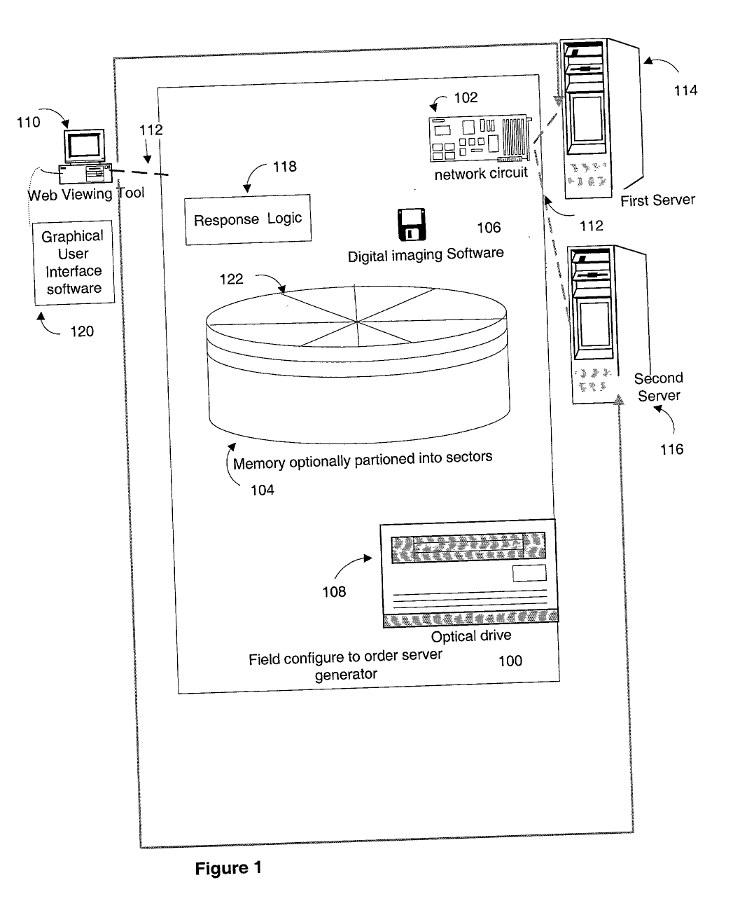

FIG. 1 illustrates a block diagram of an embodiment of a field-configure-server. In an embodiment, the field-configure-server 100 contains a network circuit 100, memory 104 such as volatile memory, non-volatile memory or both, digital imaging software 106 stored within the memory 104, a processing unit such as an application specific integrated circuit (not shown), and optionally a computer readable media drive such as, for example, an optical drive 108. In an embodiment, the field-configure-server 100 operates in conjunction with a display having a graphic user interface such as, for example, a web-viewing tool 110. In an embodiment, the web-viewing tool 110 is located in a remote location and accesses the field-configure-server 100 via a network 112. In an embodiment, the web-viewing tool 110 may be locally connected to the field-configure-server 100. In an embodiment, the web-viewing tool 110 may be a personal computer or workstation equipped to communicate via a network 112.

FIG. 1 also illustrates a first server 114 and a second server 116 connected through a network 112, such as the Internet, to the field-configure-server 100. In an embodiment, field-configure-server 100 may connect to one or more servers 114, 116 but two will be used to illustrate aspects of the invention. The field-configure-server 100 contains response logic 118, such as firmware, programmed to receive a remote boot signal. In an embodiment, the network circuit 100 establishes communications between the one or more servers 114, 116 and the field-configure-server 100.

The web-viewing tool 110 displays a graphic user interface that allows a user to use the graphic user interface software 120. The graphic user interface software 120 operates in conjunction with the digital imaging software 106 to allow a user to load software files into the digital image of the initial payload of a server. In an embodiment, the user may create a digital image of the server as it currently exists, rebuild a server in the field, add additional programs onto the initial payload of a server, add updates or patches to the initial payload of a server, and perform other similar functions. In an embodiment, the field-configure-server 100 may use digital imaging software 106 scripted to communicate with standard or proprietary server protocols.

In an embodiment, the stored digital image is compressed prior to storage and then decompressed at an appropriate stage of the graphic user interface wizard while creating the new digital image. In an embodiment, the digital image contains the operating system, programs, and configuration settings of a given server. When a new digital image is created the partition size of the destination partition of the memory is determined and the destination partition is formatted for the appropriate file and the chosen size. When the local optical drive 108 creates a digital image in the compressed format, the digital image may be contained on one disc, such as a CD ROM, or a set of discs, depending on the size of the digital image. The digital image may also be stored in one of the partitioned sections 122 of the memory 104.

Once the digital image is created, the digital image can be written to one or more CDs and a boot disc maybe used to restore the digital image when needed. The boot disc contains sufficient portions of the operating system to operate the computer for software installation and additionally contains a software script to allow the compressed image to be installed on the server. In an embodiment, a file to self execute the digital image is embedded on a chip in the server. In an embodiment, a file to self execute the digital image is attached to the digital image file. Essentially, when a user reinstalls the digital image, then the user does not have to reconfigure the server from scratch by reinstalling each program and operating system until the user returns the server to the condition it was in before it crashed.

In an embodiment, when the graphic user interface software 120 adds updates or programs to the digital image, the modified server digital image retains its fundamental purpose. For example, the target server fundamentally remains an e-mail server or a Web server. In an embodiment, when graphic user interface software 120 rebuilds a digital image, then the modified server digital image changes its fundamental purpose. The rebuilt digital image accesses logic in the target server and overlays the new digital image to change the server's purpose, such as from a network server to a print server. Thus, a server comprised of older hardware need not be shipped back to factory in order to be adapted for a new role.

The optical drive 108 allows a user to load CD's with specific images for each server from the factory or customize a digital image CD created by a user after the initial payload is loaded. The optical drive 108 also allows the creation of a portable computer readable media such as a CD, to store the digital image of a particular server. In an embodiment, the optical drive 108 may be a CD ROM drive with read-write CD burner.

The memory 104 in the field-configure-server 100 may be partitioned into sections 122 in order to contain multiple individual digital images with different payloads. For example, the first server 114 payload may be primarily an e-mail server having five application programs operating on the first server 114. Similarly, the second server 116 payload may be an e-mail server having three applications running on the server. The additional two applications on the first server 114 cause the first server 114 to have a first unique digital image, and the second server 116 to have a second unique digital image. Thus each unique digital image is stored in a separate sector 122 of the memory 100.

The graphic use interface software 120 contains a wizard program to add additional application programs onto the base payload. The wizard program also allows updates and patches to be added to the current payload and then store each new unique digital image in the memory 104. The wizard program may also assist in making a rebuilt image. Further, the wizard program assists and steps a user through making a digital image for each server onto a portable computer readable medium, such as a CD-ROM or DVD. In an embodiment, the graphical user interface software 120 accesses specific broadcast frequencies stored in firmware.

Each server 114, 116 may contain one or more operation buttons to allow a user to locally direct a server to boot. Each server 114, 116 contains logic that allows a server to accept a remote boot signal command. Upon receiving the remote boot signal, the server 114, 116 then broadcasts a specific key coded signal, such as a specific broadcast frequency, to pull the appropriate digital image from memory 104 of the field-configure-server. In an embodiment, the field-configure-server 100 contains a specific signature embedded on a chip in the response logic 118 in order to allow a digital image to be rebuilt or restored.

The field-configure-server 100 looks for a specific code key or restore frequency. Upon satisfactorily obtaining the code key or restore frequency, the field-configure-server 100 contains response logic 118 to respond to the remote boot broadcast from a server. The response logic 118 decodes the signal and then sends back a coded signal to the server allowing the field-configure-server 100 to communicate in a server protocol to the server. This system allows a remote server, such as the first server 114, to communicate with one or more field-configure-servers that contain the remote server's specific digital image. The remote server then pulls the digital image from a partitioned section 122 in the memory 104 of the field-configure-server 100 over the network 112 to the remote server, such as the first server 114. Logic on the remote server instructs the remote server on how to reboot and rebuild or restore the digital image. Also, each remote server may have an optical drive (not shown) to perform a local boot with the digital image CD's created by the factory or the field-configure-server.

As noted previously, the wizard program in the graphic user interface software 120 preforms the necessary steps and commands to add programs onto the base payload and to create a current digital image of each server. The newly created or updated digital image of the server may be also be stored on a portable computer-readable medium, such as CD ROM, through the optical drive 108 of the field-configure-server. Thus, the field-configure-server 100 may provide a warehouse of restore images for servers accessible remotely or locally through portable computer readable mediums. In an embodiment, the field-configure-server 100 is a Sun Cobalt Appliances, manufactured by Sun Microsystems, Inc., Server Appliance Business, unit 555 Ellis Street, Mountain View, Calif. In an embodiment, the servers 114, 116, web-viewing tool 110, and field-configure-server 100 may use a secure protocol such as Secure SHell (SSH) to communicate over the network 112.

In an embodiment, the field-configure-server 100 may be in communication with multiple servers at the same time. As long as all of the servers 114, 116 contain the same digital image, the network circuit 100 may restore the digital image to these multiple servers in parallel at the same time. For example, in data centers, where a rack of twenty servers may contain the same digital image, i.e., the same payload of Web servers with the same applications on them, this feature may be useful if all twenty servers need to be restored at the same time. For instance, a virus infecting every server in the data center may require each server to have its digital image restored.

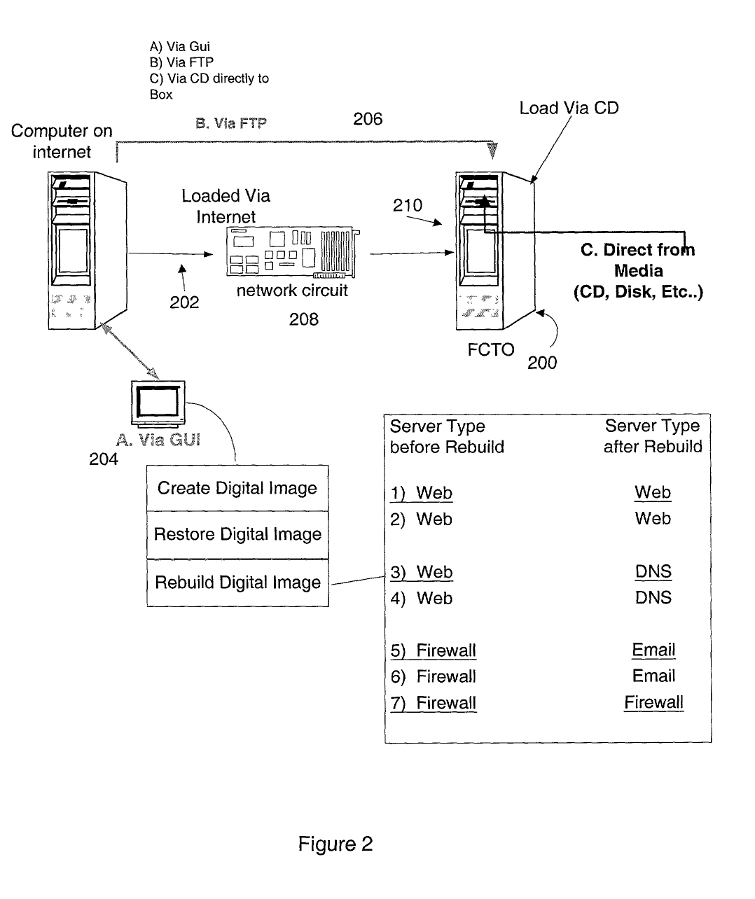

FIG. 2 illustrates a block diagram of a field-configure-server receiving loading images in several different ways. In an embodiment, the field-configure-server 200 may receive or modify stored digital images over a network connection 202 via the graphic user interface software 204. In an embodiment, the field-configure-server 200 receives the digital image over a network 206 using a communications protocol such as FTP. In both these cases the network circuit 208 facilitates these communications. In an embodiment, the field-configure-server 200 may load the images through the computer readable media drive 210 directly from portable computer readable media, such as a CD-ROM or DVD.

The digital imaging software on the field-configure-server 200 stores these digital images in the correct format to allow a server to net boot and do the specific restore function. In an embodiment, restoring a digital image to a server via the network connection is much faster than manually than loading in several sequenced portable restore CDs to restore the digital image of that particular server. This is especially true if the size of the digital image occupies multiple CD-ROMs or if multiple servers all need the same digital image restored and the digital image is restored via a network connection in parallel to all of the multiple servers.

For example, in a Web server application or an imaging server application, several gigabytes of data may be contained within the digital image of that particular server. Thus, in an embodiment, a CD-ROM disc holds 640 MB, and thus multiple CD ROMS would be required to store the entire size of that data, even though the data in the digital image is stored in a compressed format. Additionally, a human being is required to manually load each CD into the server in order to load the content of that CD ROM into the memory of the server. Manually loading multiple CDs requires much more time than loading via network connection.

As described above, the graphic user interface software 204 may allow a user to create a digital image, restore a digital image, or rebuild a digital image. As noted above, when the digital image of a server is rebuilt in the field, the hardware essentially remains the same. However, the fundamental purpose of the server changes from a first specific function to a second specific function. Thus, if a user owned a rack of seven severs and wanted to change the functions of some of the existing hardware, then the user could use the graphic user interface software 204 to rebuild those servers in the field.

For example, a user could have seven servers coupled across a network to the field-configure-server 200. The user could keep the first server and second server as Web Servers and update their current digital image to create a new digital image for those two servers. Similarly, the user could keep the seventh server as Firewall Server and update its current digital image to create a new digital image for that server. In contrast, the user may rebuild the digital image of the third server and fourth server from Web Servers to Domain Name Servers (DNS). Similarly, the user may rebuild the digital image of the fifth server and sixth server from Firewall Servers to E-mail servers. In an embodiment, the user accomplishes all these tasks from a remote location without physically moving or shipping the hardware for the server anywhere.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

A computer program may be stored in a computer readable storage medium, such as, but is not limited to, any type of disk including floppy disks, optical disks, CD-ROMs, DVD's, magnetic-optical disks, read-only memories (ROMs), random access memories (RAMs), EPROMs, EEPROMs, magnetic or optical cards, or any type of media suitable for storing electronic instructions, and each coupled to a system bus.

While some specific embodiments of the invention have been shown the invention is not to be limited to these embodiments. For example, most functions performed by electronic hardware components may be duplicated by software emulation. Thus, an electronic circuit fabricated to accomplish the same functions as the digital imaging software may emulate the functionality of digital imaging software. The response logic may be software, electronic hardware, or a combination of both. The invention is to be understood as not limited by the specific embodiments described herein, but only by scope of the appended claims.

I claim:

1. An apparatus, comprising:
a first server to restore a digital image to a second server after the initial payload has been installed, wherein the digital image is a file that contains a replica of the content of the second server;
a network circuit associated with the first server, the network circuit to transmit the digital image over a network connection to the second server; and
response logic associated with the first server, the response logic to respond to a broadcast request of the second server to restore the digital image.

2. The apparatus of claim 1, further comprising:
a computer readable media associated with the first server, the computer readable media to store the digital image associated with the second server; the computer readable media partitioned to store multiple digital images.

3. The apparatus of claim 2, wherein the digital image associated with the second server possesses files added to the payload after the initial payload.

4. The apparatus of claim 1, further comprising:
a computer readable media associated with the first server, the computer readable media to store digital imaging software to modify a digital image, the digital imaging software scripted to communicate in a protocol that a server could understand.

5. The apparatus of claim 4, wherein modify comprises rebuild.

6. The apparatus of claim 1, further comprising:
a web-viewing tool having a graphical user interface to add additional software files into an existing digital.

7. The apparatus of claim 1, wherein the second server can remotely pull the digital image from the first server.

8. The apparatus of claim 1, wherein a specific signature to allow a digital image to be modified is embedded on a chip in the first server.

9. The apparatus of claim 1, wherein the first server is a cobalt appliance.

10. The apparatus of claim 1, further comprising:
an optical device coupled to the first server.

11. The apparatus of claim 10, wherein the optical drive to produce a digital image on a portable computer readable media.

12. A method, comprising:
restoring a digital image to a server after the initial payload has been installed;
transmitting the digital image over a network connection; and
responding to a broadcast request of the server to restore the digital image.

13. The method of claim 12, wherein restoring comprises rebuilding.

14. The method of claim 12, further comprising:
storing two or more digital images on a partitioned memory.

15. The method of claim 12, further comprising:
producing the digital image on one or more portable computer readable media.

16. An apparatus, comprising:
means for restoring a digital image to a server after the initial payload has been installed;
means for transmitting the digital image over a network connection; and
means for responding to a broadcast request of the server to restore the digital image.

17. The apparatus of claim 16, further comprising:
means for storing two or more digital images on a partitioned memory.

18. The apparatus of claim 16, further comprising:
means for producing the digital image on one or more portable computer readable media.
